(19) United States
(12) Patent Application Publication
(10) Pub. No.: US 2003/0233279 A1
(43) Pub. Date: Dec. 18, 2003

(54) POS system, commodity sales managing apparatus, and purchase history browsing terminal

(75) Inventor: Takashi Shinzaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki, Japan

(21) Appl. No.: 10/464,643

(22) Filed: Jun. 19, 2003

Related U.S. Application Data
(63) Continuation of application No. PCT/JP00/09017, filed on Dec. 20, 2000.

(51) Int. Cl. G06F 17/60

(52) U.S. Cl. 705/21

(57) ABSTRACT

A POS (point-of-sale) system includes a POS terminal having an identification information obtaining section (21) to obtain, at a point of sale, identification information for identification of a customer and a commodity sales managing unit (10) has a purchase history data creating section (13) to create purchase history data from sales information, a storage (12) to store the purchase history data associated with the identification information and a sending section (11) to send, on an appointed day, the purchase history data concerning a predetermined time period to the customer. With this system, customers can conveniently use purchase history data together with household-expenditure software. This system can be constructed at a low cost and purchase history data can be effectively used.

### TECHNICAL FIELD

The present invention relates to a POS (point-of-sale) system for managing sales information obtained at a point of sale, and more particularly to a POS system, a commodity sales managing apparatus and a purchase-history-data browsing terminal, each of which is communicably connected to the Internet.

### BACKGROUND OF THE INVENTION

A common POS system comprises one or more POS terminals to obtain sales information about each commodity by reading the barcode attached to the commodity and a commodity sales managing apparatus to manage the sales information obtained by the POS terminals.

A barcode reader included in each POS terminal reads a barcode attached to each commodity, and the POS terminal and a commodity sales managing apparatus respectively register the commodity to be purchased, display the name or the price of the commodity, perform calculation, print a receipt to be issued and performs other operations on the basis of information on the commodity barcode read by the barcode reader.

Customers receive purchase receipts issued by a POS terminal and keep household expense records or manage housekeeping money with reference to information printed on the receipts. In accordance with the recent spread of personal computers to the home, users tend to keep household expense records using household-expenditure software.

To keep household expense records on such household-expenditure software, customers have to input each purchase history printed on receipts by hand, which is a complicated task.

In order to assist customers in keeping household expense records by releasing the customer from such a complicated task, various methods are proposed in Japanese Patent Application Laid-Open (KOKAI) Publications HEI 7-175858, HEI 10-177684, HEI 11-53650, and HEI 10-55384.

Patent Application Laid-Open (KOKAI) Publication HEI 7-175858 teaches a purchase history managing system in which household expenditure information is created for each customer on the basis of purchase information associated with the customer. The system utilizes a technique to forward purchase information of each customer, which information is obtained by a POS terminal, to a customer terminal via a cable and/or a wireless communication device.

Disclosure of Patent Application Laid-Open (KOKAI) Publication HEI 10-177684 refers to sending each customer purchase information by e-mail. Depression of a key for issuing a receipt by e-mail sends a customer purchase information by e-mail instead of a paper receipt.

In Patent Application Laid-Open (KOKAI) Publication HEI 11-53650, there is provided a method for sending a customer e-mail to which value-added information is attached. Each time a key for converting a receipt into e-mail, which key is arranged at a POS terminal, is depressed, an e-mail including receipt data is sent to a corresponding customer.

Patent Application Laid-Open (KOKAI) Publication HEI 10-55384 provides customers with receipt information on a web site over the Internet.

At the same time, conventional POS systems disclosed in these references have the following problems.

Patent Application Laid-Open (KOKAI) Publication HEI 7-175858 requires a terminal and an external recording medium dedicated to communication with the POS terminal in order to receive household expenditure data. In other words, customers require an initial investment for an interface for the dedicated terminal and an external recording medium to import purchase history received from a store into household-expenditure software. The POS terminal also requires additional functions for this purpose, making it uneconomical. Further, the POS system sends a customer purchase history each time the customer makes a purchase whereupon the customer has to cope with complicated management of purchase histories.

It is conceivable that a customer purchases in the same store every day. Techniques disclosed in Patent Application Laid-Open (KOKAI) Publications HEI 10-177684 and HEI 11-53650 send 30 messages by e-mail, for each month, to a customer that makes a purchase every day. The customer has to refer to purchase histories included in the 30 received messages in the form of e-mail to keep a household expense record. Despite the usage of a dedicated application, customers would find keeping a household expenditure record with reference to a large number of received e-mail messages a troublesome task.

The method of Patent Application Laid-Open (KOKAI) Publication HEI 10-55384 aims at issuing a paperless receipt but does not contemplate a case in which a customer requests a receipt for purchase. Further, the method is far from an effective use of a web site.

With the foregoing problems in view, it is a first object of the present invention to provide a POS system, at a low cost, to send customer purchase history data in a form that customers can utilize with ease so that it is possible to improve service to customers that intend to use the purchase history data on household-expenditure software whereupon the purchase history data can be used efficiently. It is a second object of the present invention to provide a commodity sales managing apparatus and a browsing terminal that are effectively used in the POS system of the first object.

### DISCLOSURE OF THE INVENTION

To attain the first object, as a first generic feature, there is provided a POS (point-of-sale) system comprising: a POS terminal for obtaining sales information about one or more commodities, which are sold to a customer, at a point of sale; and a commodity sales managing apparatus, communicably connected to the POS terminal, for managing the sales information received from said POS terminal; wherein a POS terminal having an identification information obtaining section for obtaining identification information, which is used for identification of the customer, at the point of sale so that the identification information is sent to the commodity sales managing apparatus along with the sales information; and a commodity sales managing apparatus having a purchase history data creating section for creating purchase history data by converting the sales information, received from the POS terminal, into predetermined format data, a storage for storing the purchase history data associated with the identification information, and a sending section for sending, on an appointed day, the purchase history data concerning a predetermined time period to the customer identified by the identification information.

As a preferable feature, the commodity sales managing apparatus may further comprise a digital signature applying section for applying a digital signature to the purchase history data that is to be sent to the customer by the sending section.

As a second generic feature, there is provided a A POS (point-of-sale) system comprising: a POS terminal having an identification information obtaining section for obtaining identification information, which is used for identification of the customer, at the point of sale so that the identification information is sent to the commodity sales managing apparatus along with the sales information; and a commodity sales managing apparatus having a purchase history data creating section for creating purchase history data by converting the sales information, received from the POS terminal, into predetermined format data, a storage for storing the purchase history data associated with the identification information, a sending section for sending the purchase history data stored in the storage to the customer identified by the identification information, and a digital signature applying section for applying a digital signature to the purchase history data that is to be sent to the customer by the sending section.

As another preferable feature, the sending section may send the purchase history data to the customer through the Internet and may further send the purchase history data to the customer by e-mail (electronic mail). As a further preferable feature, the POS system may further comprise a browsing terminal including an assigning section for assigning the identification information, and a display for displaying the purchase history data associated with the identification information assigned by the assigning section, which data is stored in the storage.

As a third generic feature, there is provided a POS system comprising: a POS terminal having an identification information obtaining section for obtaining identification information, which is used for identification of the customer, at the point of sale so that the identification information is sent to the commodity sales managing apparatus along with the sales information; and a commodity sales managing apparatus having a purchase history data creating section for creating purchase history data by converting the sales information, received from the POS terminal, into predetermined format data, and a storage for storing the purchase history data associated with the identification information, wherein the POS system further comprises a browsing terminal including an assigning section for assigning the identification information, and a display for displaying the purchase history data associated with the identification information assigned by the assigning section, which data is stored in the storage.

As a further preferable feature, the browsing terminal may further include an identification information reading section for reading the identification information from a medium in which the identification information is recorded, and the assigning section may assign the identification information read by the identification information reading section. As a still further preferable feature, the browsing terminal may be a portable wireless-communication terminal wirelessly and communicably connected to the commodity sales managing apparatus.

As a fourth generic feature, there is provided a POS system comprising: a POS terminal having an identification information obtaining section for obtaining identification information, which is used for identification of the customer, at the point of sale so that the identification information is sent to the commodity sales managing apparatus along with the sales information; and a commodity sales managing apparatus having a purchase history data creating section for creating purchase history data by converting the sales information, received from the POS terminal, into predetermined format data, a storage for storing the purchase history data associated with the identification information, a providing section for providing the purchase history data stored in the storage responsive to a browse request that assigns the identification information so that the purchase history data associated with the identification information is browsed, and a receipt issuing section for issuing, based on the purchase history data, a receipt for one or more purchased commodities designated with reference to the purchase history data provided by the providing section, which receipt is in the form of electronic data.

As a still further preferable feature, the commodity sales managing apparatus may further have a sending section for sending the receipt, issued by the issuing section, to the customer identified by the identification information and the sending section may send the receipt to the customer by e-mail (electronic mail).

As a still further preferable feature, the commodity sales managing apparatus may further have a digital signature applying section for applying a digital signature to the receipt that is to be sent to the customer by the sending section, and the digital signature applying section may apply the digital signature to the receipt using a secret key of the customer.

As a still further preferable feature, the receipt issuing section may issue the receipt for each of the purchased commodities designated with reference to the purchase history data provided by the providing section or a receipt for the purchased commodities, designated with reference to the purchase history data provided by the providing section, in a lump.

As a still further preferable feature, the providing section may display the purchase history data on a browse page and display value-added information on the browse page.

As a still further preferable feature, the identification information obtaining section may serve to function as an identification information reading section for reading the identification information from a medium in which the identification information is recorded.

As a still another preferable feature, the purchase history data may include date and time of purchase, information about each purchased commodity, and information of prices of each purchased commodity, and the receipt issuing section may issue the receipt in the form of electronic data including date and time of purchase, information about each purchased commodity, information of prices of each purchased commodity and information of a seller of the purchased commodities.

To accomplish the second object, as a fifth generic feature, there is provided a commodity sales managing apparatus, communicably connected to a POS terminal for obtaining sales information about one or more commodities which are sold to a customer at a point of sale, for managing the sales information received from the POS terminal, the apparatus comprising: a purchase history data creating section for creating purchase history data by converting the sales information, received from the POS terminal, into predetermined format data; a storage for storing the purchase history data associated with identification information, which is received from the POS terminal and which is used for identification of the customer; and a sending section for sending, on an appointed day, the purchase history data concerning a predetermined time period to the customer identified by the identification information, which data is stored in the storage.

As a sixth generic feature, there is provided a commodity sales managing apparatus, communicably connected to a POS terminal for obtaining sales information about one or more commodities which are sold to a customer at a point of sale, for managing the sales information received from the POS terminal, the apparatus comprising: a purchase history data creating section for creating purchase history data by converting the sales information, received from the POS terminal, into predetermined format data; a storage for storing the purchase history data associated with identification information, which is received from the POS terminal and which is used for identification of the customer; a sending section for sending the purchase history data stored in the storage to the customer identified by the identification information; and a digital signature applying section for applying a digital signature to the purchase history data that is to be sent to the customer by the sending section.

As a seventh generic feature, there is provided a commodity sales managing apparatus, communicably connected to a POS terminal for obtaining sales information about one or more commodities which are sold to a customer at a point of sale, for managing the sales information received from the POS terminal, the apparatus comprising: a purchase history data creating section for creating purchase history data by converting the sales information, received from the POS terminal, into predetermined format data; a storage for storing the purchase history data associated with identification information, which is received from the POS terminal and which is used for identification of the customer; a providing section for providing the purchase history data stored in the storage responsive to a browse request that assigns the identification information so that the purchase history data associated with the identification information is browsed; and a receipt issuing section for issuing, based on the purchase history data, a receipt for one or more purchased commodities designated with reference to the purchase history data provided by the providing section, which receipt is in the form of electronic data.

To attain the second object, as an eighth generic feature, as a tenth generic feature, there is provided a purchase history data browsing terminal provided in a POS (point-of-sale) system comprising a POS terminal for obtaining sales information about one or more commodities, which are sold to a customer, at a point of sale and a commodity sales managing apparatus, communicably connected to the POS terminal, for managing the sales information received from the POS terminal, wherein the POS terminal has an identification information obtaining section for obtaining identification information, which is used for identification of the customer, at the point of sale so that the identification information is sent to the commodity sales managing apparatus along with the sales information, and the commodity sales managing apparatus has a purchase history data creating section for creating purchase history data by converting the sales information, received from the POS terminal, into predetermined format data, and a storage for storing the purchase history data associated with the identification information, the purchase history data browsing terminal comprising: an assigning section for assigning the identification information; and a display for displaying the purchase history data associated with the identification information assigned by the assigning section, which data is stored in the storage.

As a preferable feature, the browsing terminal may further comprise an identification information reading section for reading the identification information from a medium in which the identification information is recorded, and the assigning section may assign the identification information read by the identification information reading section. As another preferable feature, the purchase history data browsing terminal may be a portable wireless-communication terminal wirelessly and communicably connected to the commodity sales managing apparatus.

A POS terminal, a commodity sales managing apparatus and a purchase history data browsing terminal of the present invention, having the above generic and preferable features, guarantee the following advantages:

(1) Since the purchase history data concerning a predetermined time period is sent to a customer identified by the identification information on an appointed day, the customer can conveniently make use of the purchase history data concerning the predetermined time period all at the same time.

(2) Application of a digital signature to purchase history data to be sent to a customer improves the authenticity of the purchase history data and avoids unscrupulous use of the purchase history data by third parties.

(3) Sending of purchase history data to a customer through the Internet makes it possible to construct the POS system of the present invention at a low cost.

(4) Purchase history data is sent to a customer by e-mail, so that the customer can receive the purchase history data with ease.

(5) Since the POS system includes an assigning section for assigning the identification information and a display for displaying the purchase history data associated with the identification information assigned by the assigning section, which data is stored in the storage, the customer can browse the purchase history data with ease and thereby improve the service to the customer.

(6) A customer does not have to input the identification information into a browsing terminal (a purchase history data browsing terminal) by hand because the browsing terminal comprises an identification information reading section for reading the identification information from a medium in which the identification information is recorded and the assigning section assigns the identification information read by the identification information reading section. As a result, it is possible to improve the convenience provided for customers.

(7) A browsing terminal (a purchase history data browsing terminal) is in the form of a portable wireless-communication terminal wirelessly and communicably connected to the commodity sales managing apparatus, so that a customer may carry the browsing terminal in the store whereupon service to the customer can be improved.

(8) Since the commodity sales managing apparatus includes a providing section for providing the purchase history data stored in the storage responsive to a browse request that assigns the identification information so that the purchase history data associated with the identification information is browsed, the customer can browse the purchase history data with ease and thereby service to customers can be improved.

(9) It is possible for customers to obtain a receipt with ease so that convenience to the customer can be enhanced.

(10) Application of a digital signature to a receipt to be issued to a customer improves the authenticity of the purchase history data and avoids unscrupulous use of the issued receipt by a third party.

(11) Since the commodity sales managing apparatus issues a receipt for each purchased commodity and a receipt for a number of purchased commodities in a lump in accordance with designation with reference to the purchase history data provided by the providing section, it is possible to issue one or more receipts in a manner a customer wishes on the basis of the usage of the prospective issued receipt so that service to customers can be improved.

(12) Display of the purchase history data and value-added information on a browse page makes it possible for the store to provide customers with the value-added information at a reduced cost whereupon the store can benefit from economical advantages.

(13) Since the identification information obtaining section serves to function as an identification information reading section for reading the identification information from a medium in which the identification information is recorded, it is possible to obtain identification information with ease.

Other objects and further features of the present invention will be apparent from the following detailed description when read in conjunction with the accompanying drawings.

### BRIEF DESCRIPTION OF THE DRAWINGS

FIG. 1 is a block diagram schematically showing a POS system according to a first embodiment;

FIG. 2 is a flow chart illustrating a succession of procedural steps of sending purchase history data to a customer in the POS system of FIG. 1;

FIG. 3 is a block diagram schematically showing a POS system according to a modification of the first embodiment;

FIG. 4 is a block diagram schematically showing a POS system according to a second embodiment;

FIG. 5 is a diagram illustrating an example of purchase history data that a commodity sales managing unit sends to a customer in the POS system of FIG. 4;

FIG. 6 is a flow chart illustrating a succession of procedural steps of sending purchase history data to a customer in the POS system of FIG. 4;

FIG. 7 is a block diagram schematically showing a POS system according to a third embodiment;

FIG. 8 is a diagram illustrating an example of purchase history data that a commodity sales managing unit sends to a customer in the POS system of FIG. 7;

FIG. 9 is a flow chart illustrating a succession of procedural steps of sending purchase history data, in receipt form, to a customer in the POS system of FIG. 7;

FIG. 10 is a block diagram schematically showing a POS system according to a fourth embodiment;

FIG. 11 is a diagram illustrating a configuration of a browsing terminal used in the POS system of FIG. 10;

FIG. 12 is a flow chart illustrating a succession of procedural steps of creating tag-language-converted household expenditure data for individual customers in the POS system of FIG. 10;

FIG. 13 is a flow chart illustrating a succession of procedural steps of browsing purchase history data on the browsing terminal of FIG. 11;

FIG. 14 is a block diagram schematically showing a POS system according to a modification of the fourth embodiment;

FIG. 15(a) is a block diagram schematically showing a POS system according to a fifth embodiment, and

FIG. 15(b) is a diagram illustrating an example of tag-language-converted customer household expenditure data to be displayed on the display of a customer terminal in the POS system of FIG. 15(a);

FIG. 16 is a diagram illustrating a screen to be displayed on the display of a customer terminal in the POS system of FIG. 15 in order to request issuing of a receipt; and

FIG. 17 is a diagram illustrating an example of a receipt to be sent to a customer from a commodity sales managing unit in the POS system of FIG. 16 by e-mail (electronic mail).

### BEST MODE FOR CARRYING OUT THE INVENTION

Various embodiments of the present invention will be described hereinafter with reference to the accompanying drawings.

(A) First Embodiment:

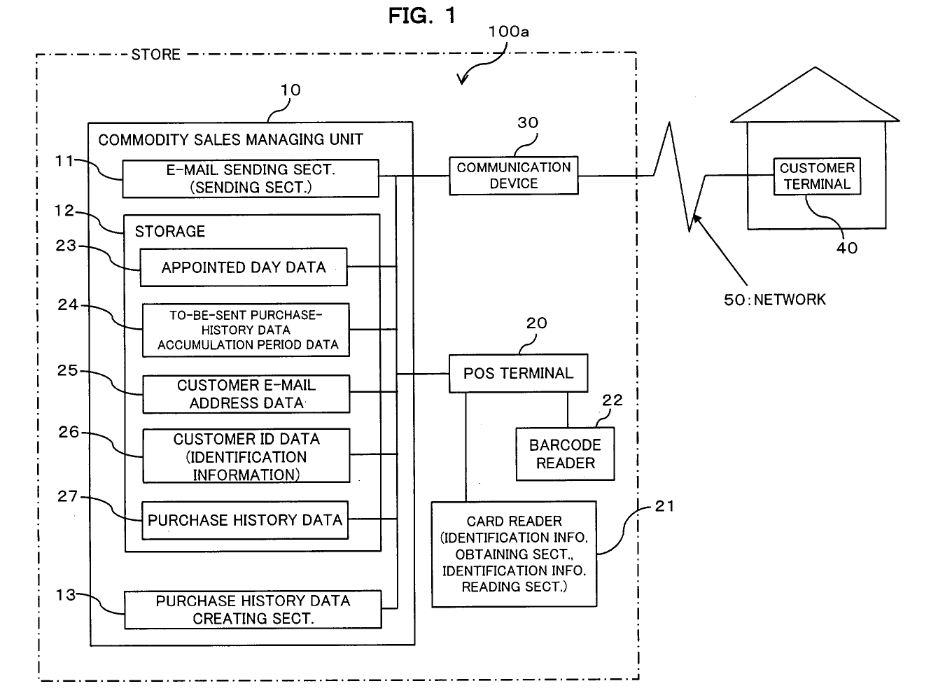

FIG. 1 is a block diagram schematically showing POS system 100a according to the first embodiment.

POS system 100a according to the first embodiment of the present invention, as shown in FIG. 1, includes POS terminal 20 and commodity sales managing unit (commodity sales managing apparatus) 10, which are installed in the same store.

Commodity sales managing unit 10 includes storage 12 to store files (not shown) including commodity information, such as commodity name and price, corresponding to a commodity code previously allocated to each commodity.

A barcode representing a commodity code is previously printed on a package of each commodity or a sticker on which a barcode is printed is stuck on the package so that POS terminal 20 reads a bar code using barcode reader 22 to obtain a commodity code of a corresponding commodity.

On the basis of information of a read commodity code, POS terminal 20 and commodity sales managing unit 10 respectively register a commodity to be purchased, display the name or the price of the commodity, perform calculation, print a receipt to be issued and perform other operations.

Commodity sales managing unit 10 is communicably connected to POS terminal 20 and manages sales information received from POS terminal 20. Commodity sales managing unit 10 includes e-mail sending section (sending section) 11, storage 12 and purchase history data creating section 13.

Purchase history data creating section 13 creates purchase history data 27 by converting sales information that is received from commodity sales managing unit 10 into a predetermined data format.

Purchase history data 27 represents sales information of one or more commodities and includes commodity name, unit price, quantity, bill amount (total amount), date and time of purchase, vender information used to identify a store that sold the commodities and the like. Alternatively, purchase history data 27 should by no means be limited to the above items, and may include other items.

Storage 12 manages and retains various information pieces, such as appointed day data 23 to send e-mail, to-be-sent purchase history/accumulation period data 24, customer e-mail address data 25, customer ID data (identification information) 26, and purchase history data 27.

Appointed day data 23 to send e-mail, to-be-sent purchase history/accumulation period data 24, customer e-mail address data 25 and purchase history data 27 are stored associated with each customer ID.

Customer ID data 26 is customer IDs, identification information used for identifying each customer, and is set for each customer. Customer IDs are uniquely allocated to individual customers for management of purchase history data 27 of the corresponding individual customers, and do not always have to link to the address, name, and telephone number of the customers.

Appointed day data 23 represents appointed days on which purchase history data 27 is sent to individual customers by e-mail and is in correlation with the respective customer IDs. Each customer previously sets appointed day data 23. For example, an appointed day to send e-mail stored in appointed day data 23 may be a monthly pay day, or a monthly pay day and a day half-way between two pay days (half-month). An appointed day may be other than the above examples.

To-be-sent purchase history/accumulation period data 24 represents the starting and the end days of a time period during which purchase history data 27 for each customer is accumulated, and is stored in relation to individual customers. An accumulation time period for accumulation of to-be-sent purchase history/accumulation period data 24 is previously determined by each customer, such as a one-month or half-month period. An accumulation time period should by no means be limited to the above examples.

Customer e-mail address data 25 represents a customer e-mail address to which purchase history data 27 for each customer is sent and is stored associated with the individual customer IDs. An e-mail address should by no means correspond to a customer ID. Namely, for example, if an e-mail address is shared by a number of people, such as company workers or family members, the single e-mail address can be related with a number of customer IDs.

Purchase history data 27 is created by purchase history data creating section 13 so as to represent a commodity purchase history of each customer and stored in correlation with each customer ID. When card reader 21 or the like of POS terminal 20, which is later described, reads a customer ID, purchase history data 27 is stored in storage 12 in correlation with the read customer ID.

E-mail sending section 11 functions as a sending section to send, on an appointed day registered in appointed day data 23, purchase history data 27 concerning a predetermined time period, which is purchase history data 27 and is stored in storage 12, to a customer identified by a corresponding customer ID.

E-mail sending section 11 sends purchase history data 27 to a customer by e-mail via communication device 30 and network 50. Purchase history data 27 to be sent is in a format of a plain text; a tagged document exemplified by HTML and XML; a spreadsheet encoded in the form of attached e-mail; a word-processing file encoded in the form of attached e-mail; or a database table encoded in the form of attached e-mail. A format of purchase history data 27 should by no means be limited to the foregoing examples, and may be in an alternative format.

Communication device 30 communicably connects commodity sales managing unit 10 to network 50 and is realized by a networking device such as a LAN board. Network 50 communicably connects commodity sales managing unit 10 and each customer terminal 40 and is exemplified by the Internet.

POS terminal 20 obtains sales information of commodities sold to customers at points of sale, and has card reader (an identification information obtaining section, an identification information reading section) 21 and barcode reader 22. POS terminal 20 sends commodity sales managing unit 10 a customer ID (identification information used for identification of each customer) read by card reader 21 and commodity sales information read by barcode reader 22.

Card reader 21 reads data from a card (a medium) in which a customer ID is recorded to obtain the customer ID. A customer ID is previously registered in a card (for example, a magnetic card or an IC card), which may be dedicated to identification of a customer or may serve as a so-called point or member card used to accumulate points or the like representing prospective service to be provided in accordance with a sales amount. Alternatively, a credit card in the form of an IC card may reserve regions each of which is dedicated to the store or the store group and a customer ID may be recorded in the corresponding region. Further, a barcode representing a customer ID may be attached to the surface of a card, and in this case, it is possible for barcode reader 22 to function as card reader 21.

Card reader 21 reads a customer ID registered in a card presented by a customer when the customer is to arrange a payment at POS terminal 20 and then sends the read customer ID to POS terminal 20. In other words, card reader 21 serves as an identification information reading section for reading a customer ID from a card on which the customer ID is recorded. Further, such a function causes card reader 21 to also function as an identification information obtaining section to obtain identification information used for identification of a customer at a point of sale so that the obtained identification information is sent to commodity sales managing unit 10 along with sales information of one or more commodities purchased by the customer.

Barcode reader 22 reads a barcode attached to each commodity and sends read information to POS terminal 20.

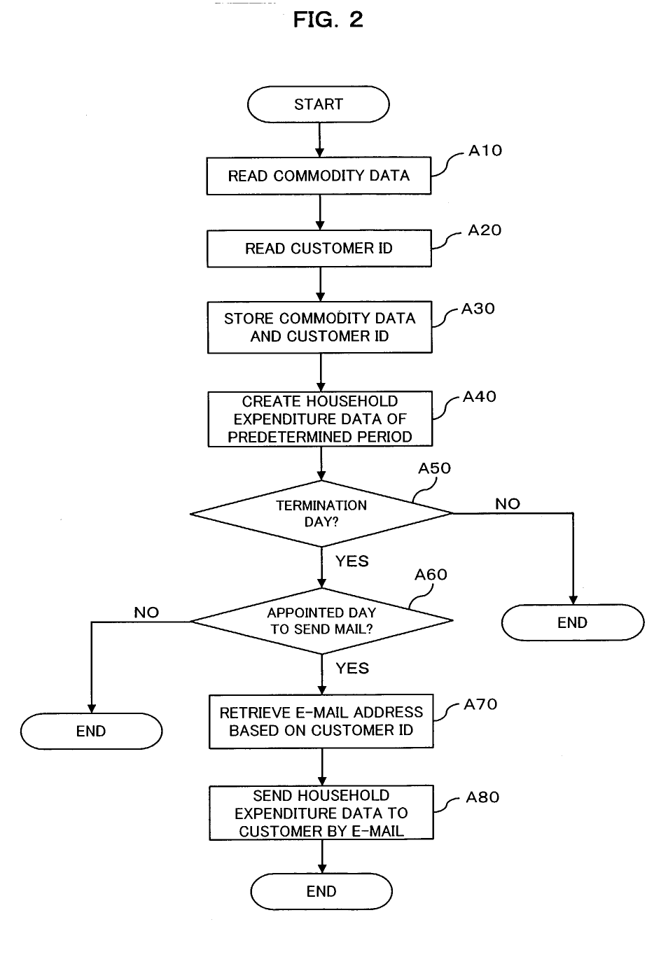

A succession of procedural steps (steps A10 to A80) of sending purchase history data 27 to a corresponding customer in POS system 100a having the above-mentioned configuration will now be described with reference to flow chart FIG. 2.

First of all, a customer takes one or more commodities that the customer wishes to purchase to a cash register in the store. Barcode reader 22 operated by a cashier reads barcodes attached to the commodities, so that POS terminal 20 obtains sales information including commodity name, quantity, price and the like (step A10) and sends the sales information to commodity sales managing unit 10. At that time, card reader 21 installed at POS terminal 20 reads the customer ID from a card presented by the customer (step A20).

Commodity sales managing unit 10 stores sales data (commodity data), which has been sent from POS terminal 20 and which concerns a predetermined time period, together with the customer ID (step A30), and accumulates the sales data for each customer ID. Thereby, purchase history data 27 concerning the predetermined time period is created from the accumulated sales data and is stored in storage 12 (step A40). Hereinafter, the purchase history data 27 concerning the predetermined time period is also called household expenditure data.

Commodity sales managing unit 10 refers to to-be-sent purchase history/accumulation period data 24 and determines whether or not it is an end day (termination day) of the predetermined time period of accumulation of purchase history data 27 for the customer (step A50). If it is not the termination day (no route in step A50), the procedural steps are completed.

On the other hand, if it is the termination day (yes route in step A50), commodity sales managing unit 10 subsequently refers to appointed day data 23 in order to determine whether or not it is the appointed day to send purchase history data 27 to the customer by e-mail (step A60). If it is not the appointed day (no route in step A60), the procedural steps are completed.

Conversely, if it is the appointed day (yes route in step A60), commodity sales managing unit 10 refers to customer e-mail address data 25 to retrieve the e-mail address corresponding to the customer ID (step A70).

After that, commodity sales managing unit 10 sends the household expenditure data to the retrieved customer e-mail address (step A80).

After receipt of the e-mail by customer terminal 40, the customer imports the purchase history data 27 sent in the form of e-mail into household-expenditure software to keep a household expense record.

As described above, POS system 100a according to the first embodiment can remove loads on customers to accumulate receipts and input data into household-expenditure software whereupon it is possible to provide more convenient service to the customers. Further, commodity sales managing unit 10 accumulates purchase history data 27 concerning a predetermined time period for each customer in storage 12 and sends the accumulated data to the customer, whereby the customer receives purchase history data 27 concerning the predetermined time period in a lump. That eliminates the requirement to sum up a number of purchase histories and improves the service to the customers.

For example, if commodity sales managing unit 10 sends each customer purchase history data 27 in the form of a file format for spreadsheet software (e.g., MS®-EXCEL, products of Microsoft® Corporation), the customer plots the received purchase history data 27 into a graph, which is advantageously used for checking on a share of food stuff or daily necessaries among the entire household expense, or for checking on a move in cost for each commodity.

For the benefit of the store, spreadsheet files or e-mail to be sent to customers may include information, such as a bargain schedule for the next month. This reduces advertisement costs and at the same time contributes to creating repeat customers.

Since purchase history data 27 is sent to customers through the Internet of an existing infrastructure, system costs can be reduced.

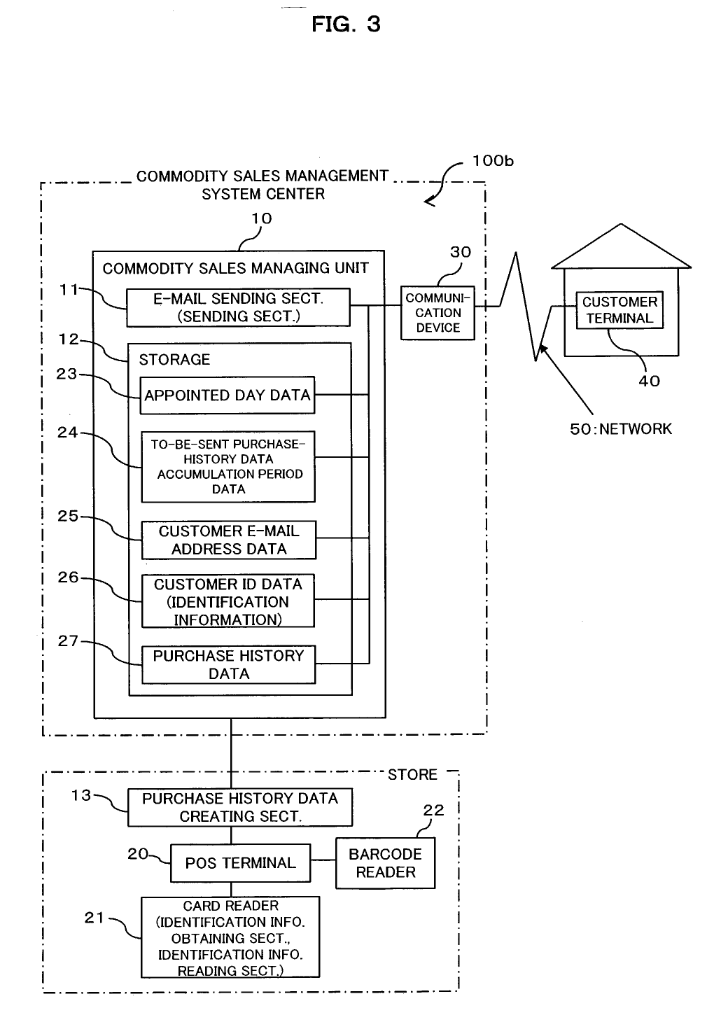

FIG. 3 is a block diagram schematically showing POS system 100b according to a modification of the first embodiment. In POS system 100b of FIG. 3, commodity sales managing unit 10 is disposed at a different place (a commodity sales management system center) from the store in which POS terminal 20 is arranged. Purchase history data creating section 13 is arranged in the store as well as POS terminal 20. Like reference numbers designate similar or substantially similar parts or elements throughout the above description, so any repetitious description is omitted here.

As shown in FIG. 3, POS terminal 20 and purchase history data creating section 13 are not necessarily arranged in the same place as commodity sales managing unit 10. Alternatively, purchase history data creating section 13 may be arranged in the same place as that of commodity sales managing unit 10. Placement of commodity sales managing unit 10, POS terminal 20 and purchase history data creating section 13 can be changed or modified without departing from the concept of the present invention.

POS system 100b of the modification ensures the same advantages as those obtained by the POS system 100a of the first embodiment.

(B) Second Embodiment:

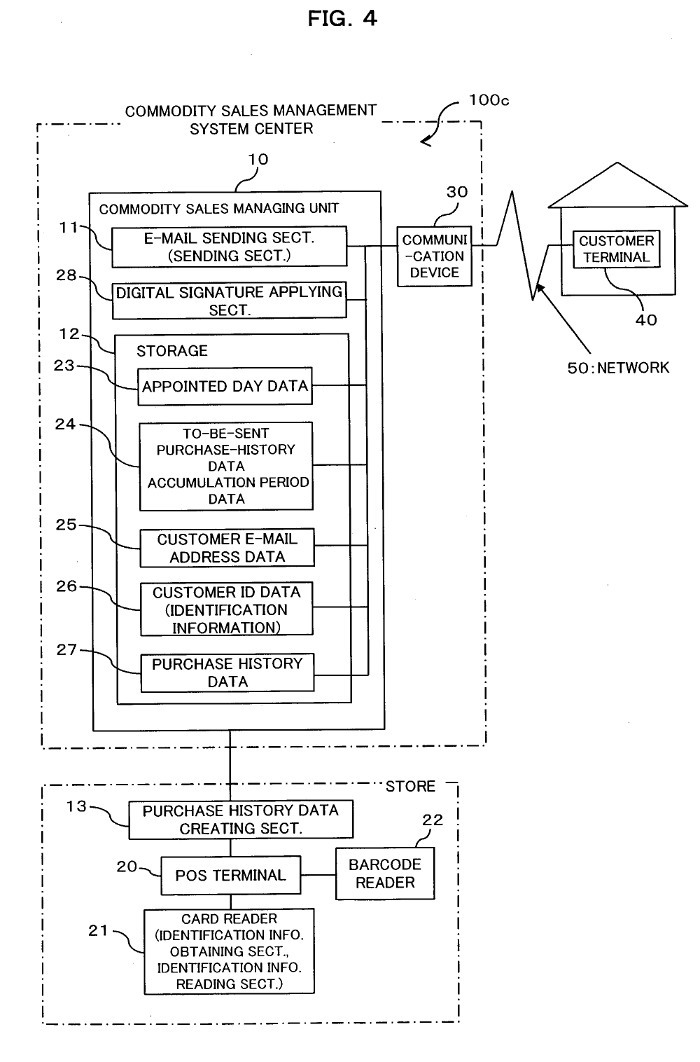

FIG. 4 is a block diagram schematically showing POS system 100c according to a second embodiment of the present invention. As shown in FIG. 4, POS system 100c of the second embodiment further includes digital signature applying section 28 disposed in commodity sales managing unit 10 in addition to POS system 100b of the above modification. Like reference numbers designate similar parts or elements throughout several views of different illustrated examples, so any repetitious description is omitted here.

Digital signature applying section 28 applies a digital signature of purchase history data 27 to be sent to each customer by e-mail sending section 11. For example, a digital signature is applied by using a message digest method.

In POS system 100c of the second embodiment, digital signature applying section 28 uses a digital signature (the store digital signature) of the store and a digital certificate (the store digital certificate) of the store proves that the digital signature belongs to the store in order to apply a digital signature to purchase history data 27.

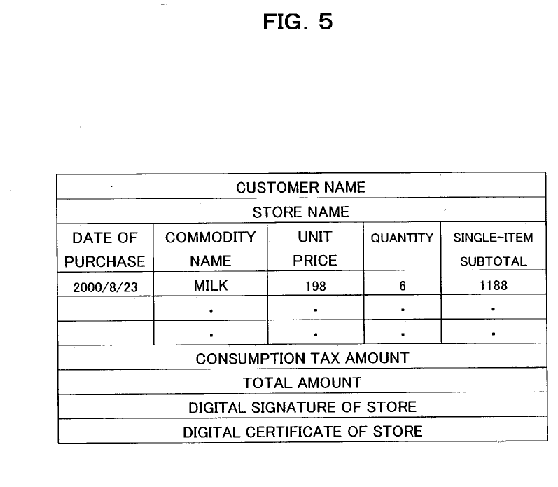

FIG. 5 is a diagram illustrating an example of purchase history data 27 that commodity sales managing unit 10 sends to a customer in POS system 100c. As shown in FIG. 5, digital signature applying section 28 attaches the store digital signature and the store digital certificate to purchase history data 27 to be sent to each customer.

After receipt of the sent purchase history data 27, the customer verifies the received purchase history data 27 using a public key of the store, so that the customer can confirm that the received data has definitely been issued by the store.

In addition to the store digital signature and the store digital certificate, digital signature applying section 28 may attach a digital signature (the customer digital signature) of a customer created by using the public key of the customer to the purchase history data 27 to be sent to the customer. The customer digital signature can prove that the sent purchase history data 27 has definitely been issued to the customer by the store.

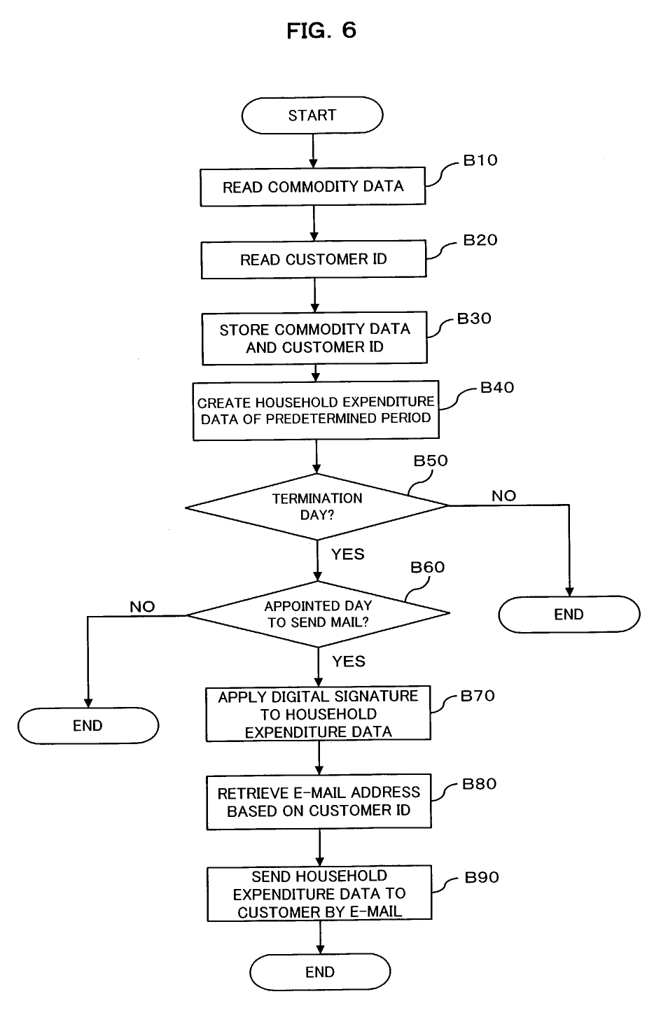

A succession of procedural steps (steps B10 to B90) of sending purchase history data 27 to a customer in POS system 100c will now be described with reference to flow chart FIG. 6.

First of all, a customer takes one or more commodities that the customer wishes to purchase to a cash register in the store. Barcode reader 22 operated by a cashier reads barcodes attached to the commodities, so that POS terminal 20 obtains sales information including commodity name, quantity, price and the like (step B10) and sends the sales information to commodity sales managing unit 10. At that time, card reader 21 installed at POS terminal 20 operated by the cashier reads the ID of the customer from a card presented by the customer (step B20).

Commodity sales managing unit 10 stores sales data (commodity data) which has been sent from POS terminal 20 and which concerns a predetermined time period together with the customer ID (step B30), and accumulates the sales data for individual customer IDs. Thereby, purchase history data 27 (household expenditure data) related to a predetermined time period is created from the accumulated sales data and then stored in storage 12 (step B40).

Commodity sales managing unit 10 refers to to-be-sent purchase history/accumulation period data 24 and determines whether or not it is an end day (termination day) of the predetermined time period of accumulation of purchase history data 27 for the customer (step B50). If the result of the determination is negative (no route in step B50), the procedural steps are completed.

On the other hand, if the result of the determination is positive (yes route in step B50), commodity sales managing unit 10 further refers to appointed day data 23 in order to determine whether or not it is the appointed day to send purchase history data 27 to the customer by e-mail (step B60). If it is not the appointed day (no route in step B60), the procedural steps are completed.

Conversely, if it is the appointed day (yes route in step B60), digital signature applying section 28 in commodity sales managing unit 10 applies a digital signature to the household expenditure data (step B70) and then retrieves the e-mail address corresponding to the customer ID (step B80). After that, commodity sales managing unit 10 sends the household expenditure data to the retrieved e-mail address (step B90).

After the receipt of the e-mail by customer terminal 40, the customer imports the purchase history data 27 sent in the form of e-mail into household-expenditure software to keep a household expense record or utilizes the purchase history data 27 as a receipt for various purposes.

As mentioned above, POS system 100c of the second embodiment guarantees advantages identical to those of the first embodiment. Additionally, since POS system 100c applies a digital signature to purchase history data 27, it is possible to prove that the purchase history data 27 has been issued by the store, thereby improving authenticity of the purchased history data.

A digital signature applied to purchase history data 27 ensures the reliability of the data used as a receipt.

A self-employed person and a sole proprietor require receipts to make a tax declaration. If digital signatures are legally approved in the feature, receipts to which digital signatures are applied would be formal documents when filing a final tax return or blue-form tax return. POS system 100c of the second embodiment is of further benefit to customers.

In POS system 100c of the second embodiment, each customer receives a receipt for purchases of a plurality of commodities in a lump whereupon the self-employed customer does not have to request a receipt for each purchase. As an advantage for the store, a cashier does not have to issue a receipt for each purchase whereupon workload on the cashier can be reduced.

(C) Third Embodiment:

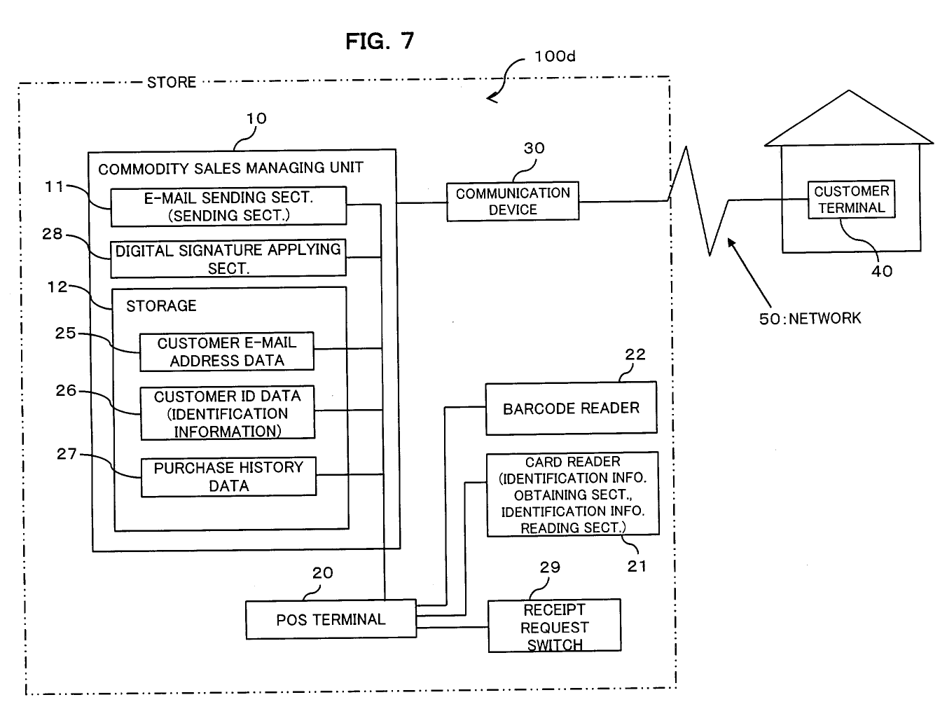

FIG. 7 is a block diagram schematically showing POS system 100d according to a third embodiment. As shown in FIG. 7, POS system 100d is similar in configuration to POS system 100a of the first embodiment, but does not include appointed day data 23 and to-be-sent purchase history/accumulation period data 24 in storage 12 of commodity sales managing unit 10. Meanwhile, POS system 100d includes digital signature applying section 28, identical to that of the second embodiment, in commodity sales managing unit 10, and receipt request switch 29 at POS terminal 20. Like reference numbers designate similar or substantially similar parts or elements throughout the above description, so any repetitious description is omitted here.

Receipt request switch 29 switches POS system 100d to a receipt-issuing mode and is arranged at POS terminal 20. When a customer requests a receipt for a purchase, the cashier depresses receipt request switch 29 and POS system 100d functions in a receipt-issuing mode.

More specifically, depression of receipt request switch 29 causes e-mail sending section 11 to send a receipt containing a purchase history record representing a current commodity purchase arranged at POS terminal 20 to the customer e-mail address.

The receipt is a copy of purchase history data 27 created by accumulating one or more commodities whose barcodes have been read, when receipt request switch 29 is depressed, at POS terminal 20.

Digital signature applying section 28 of the third embodiment executes the same function as that of the second embodiment and additionally applies a digital signature using a public key of each customer.

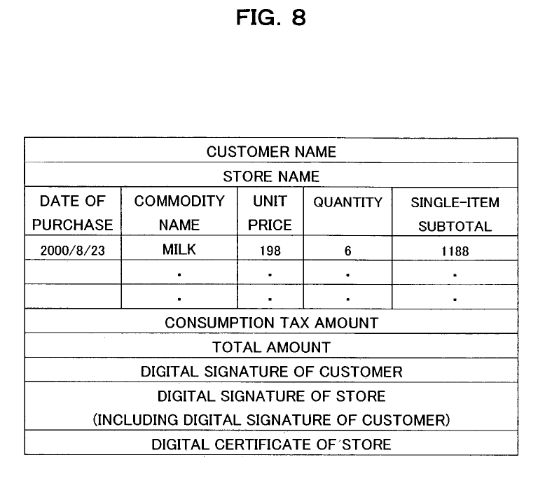

FIG. 8 is a diagram illustrating an example of purchase history data 27 that a commodity sales managing unit 10 sends to a customer in POS system 100d according to the third embodiment. As shown in FIG. 8, the purchase history data 27 includes the digital signature (customer digital signature) applied using a public key of a customer, in addition to the store digital signature and the store digital certificate.

Customer public keys may be previously stored in commodity sales managing unit 10 in correlation with the individual customer IDs, or may be previously stored in cards whose information is to be read by card reader 21. Digital signature applying section 28 obtains a customer public key and also applies a signature using the obtained public key to data to be sent to the customer.

Application of a digital signature, using a customer public key, to a receipt proves that the receipt has definitely been issued to the customer.

Alternatively, if a customer does not have a public key, digital signature applying section 28 may apply a digital signature to data to be sent to the customer using the store digital signature and the store digital certificate in the same manner as that performed by digital signature applying section 28 of POS system 100c of the second embodiment.

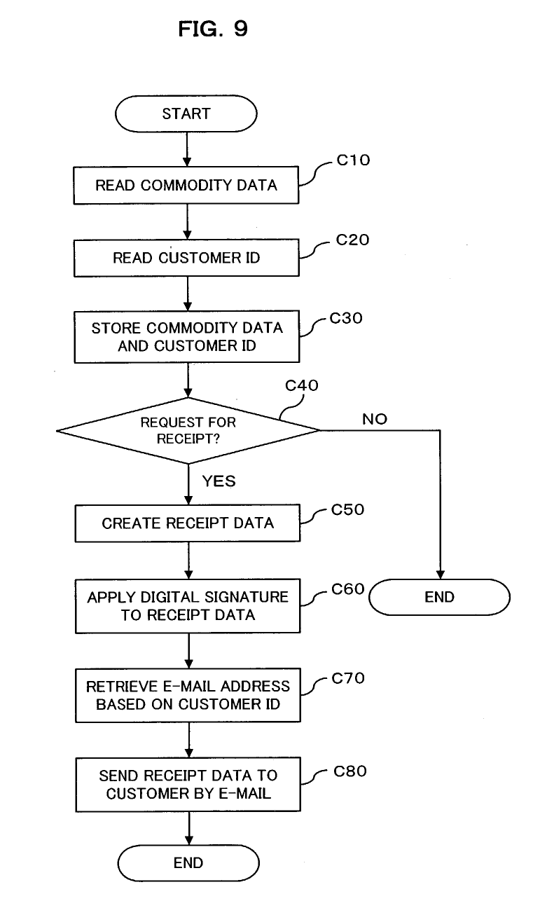

A succession of procedural steps (steps C10 to C80) of sending purchase history data 27 to be used as a receipt to a customer in POS system 100c having the above-mentioned configuration will now be described with reference to flow chart FIG. 9.

First of all, a customer takes one or more commodities that the customer wishes to purchase to a cash register in the store. If the customer requests a receipt for the commodities, a cashier depresses receipt request switch 29.

Barcode reader 22 operated by the cashier reads barcodes attached to the commodities, so that POS terminal 20 obtains sales information (commodity data) including commodity name, quantity, price and the like (step C10) and sends the sales information to commodity sales managing unit 10. At that time, card reader 21 included in POS terminal 20 reads customer ID from a card presented by the customer (step C20).

Commodity sales managing unit 10 accumulates purchase history data 27, which is received from POS terminal 20 and which is associated with the individual customer IDs, and stores the accumulated data in storage 12 (step C30).

Commodity sales managing unit 10 determines whether or not receipt request switch 29 has been depressed in order to request a receipt issue (step C40). If the result of the determination is negative (no route in step C40), the procedural steps are completed.

If the result of the determination is positive (yes route in step C40), commodity sales managing unit 10 creates data for a receipt on the basis of the purchased history data for the customer (step C50).

After that, digital signature applying section 28 of commodity sales managing unit 10 applies a digital signature to the receipt (step C60) and retrieves an e-mail address corresponding to the read customer ID in customer e-mail address data 25 (step C70).

Further, commodity sales managing unit 10 sends the receipt to the retrieved customer e-mail address by e-mail (step C80).

The customer extracts data of the receipt from the e-mail received by customer terminal 40 and uses the receipt data for a final tax declaration or a blue-form tax declaration.

In POS system 100d having the above-mentioned configuration, a customer does not have to wait for a receipt to be issued at the cash register while obtaining the receipt by e-mail afterwards. Advantageously to the store, it is possible to attend to customers requiring receipts without stacking the cash register with customers waiting for payment whereupon service to customers is improved.

Further, since digital signature applying section 28 applies a digital signature to a receipt to be issued to a customer using a corresponding public key of the customer, it is possible to prove that the receipt issued by the store is definitely destined for the customer and to prevent the receipt from being unscrupulously used by a third party.

If public keys for individual customers are previously stored in cards whose information is to be read by card reader 21, pos system 100d can obtain a customer public key with ease.

(D) Fourth Embodiment:

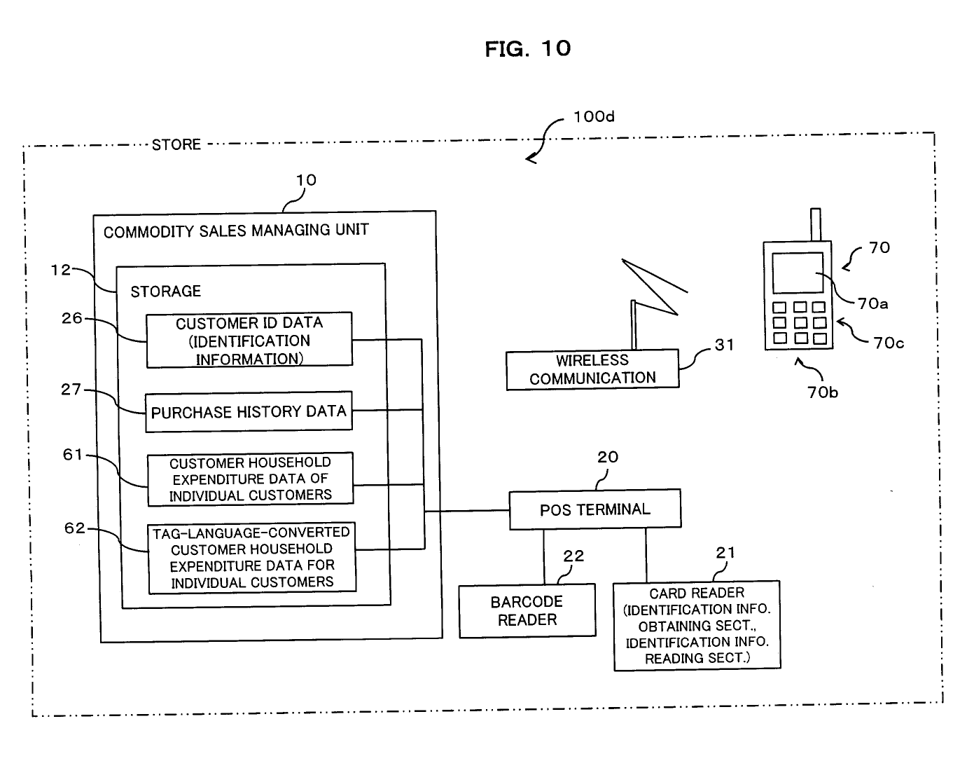

FIG. 10 is a block diagram schematically showing POS system 100e according to the fourth embodiment of the present invention. As shown in FIG. 4, POS terminal 100e comprises commodity sales managing unit 10, POS terminal 20, wireless communication device 31, and browsing terminal 70. Like reference numbers designate similar or substantially similar parts or elements throughout the above description, so any repetitious description is omitted here.

Commodity sales managing unit 10 includes storage 12 that stores therein customer ID data 26, purchase history data 27, customer household expenditure data 61 for individual customers, and tag-language-converted customer household expenditure data 62 for individual customers.

Customer household expenditure data 61 represents purchase history data 27 which is accumulated in association with individual customers and which is arranged in accordance in a predetermined order. Tag-language-converted customer household expenditure data 62 is created by converting customer household expenditure data 61 into a tag-language document and can be browsed by the use of browsing software.

Commodity sales managing unit 10 functions as a commodity sales managing server (a WWW server) to disclose tag-language-converted customer household expenditure data 62 for an individual customer on a web page (a browse page) responsive to a browsing request from browsing terminal 70.

Browsing terminal 70 is communicably connected to commodity sales managing unit 10 via wireless communication device 31, and has display 70a that displays tag-language-converted customer household expenditure data 62 for individual customers, which data is managed by commodity sales managing unit 10.

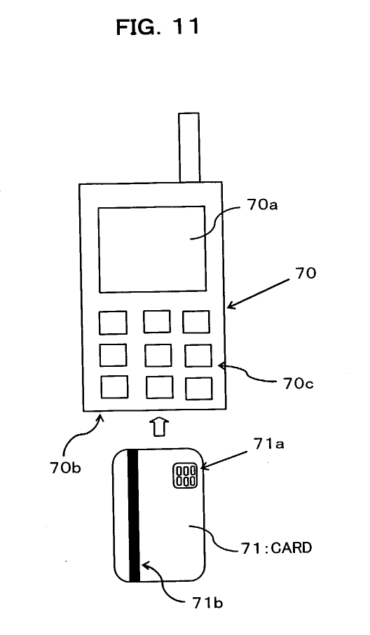

FIG. 11 is a diagram illustrating a configuration of browsing terminal 70 used in POS system 100e of the fourth embodiment. As shown in FIG. 11, browsing terminal 70 includes keyboard (an assigning section) 70c, display 70a and card slot (an assigning section) 70b.

In browsing terminal 70 is installed software (e.g., Microsoft® Internet Explorer) able to display tag-language documents whereby it is possible to make display 70a display tag-language documents (tagged document).

Further, browsing terminal 70 is a portable wireless-communication terminal communicably and wirelessly connected to commodity sales managing unit 10.

Card slot 70b receives a card which is inserted into browsing terminal browsing terminal 70 and in which a customer ID has been registered. When a customer inserts a card into card slot 70b, browsing terminal 70 reads the customer ID that is registered in the inserted card. This allows a customer to assign the corresponding customer ID without inputting the ID from keyboard 70c. In other words, card slot 70b serves as an identification information reading section to read a customer ID from a card in which the customer ID has been previously recorded, and further serves as an assigning section to assign a customer ID (identification information) read from a card.

The main power of browsing terminal 70 is applied upon inserting a card into card slot 70b.

Here, a card retaining a customer ID may be dedicated to identification of a customer or may serve as a so-called point or member card used to accumulate points or the like representing prospective service to be provided in accordance with a sales amount. Alternatively, a credit card in the form of an IC card may reserve regions each of which is dedicated to the store or the store group and a customer ID may be recorded in the corresponding region.

In the example of FIG. 11, card 71 is in the form of an IC. When card 71 is inserted into card slot 70b, the customer ID previously recorded in IC chip 71a or magnetic storing section 71b is read by browsing terminal 70.

Display 70a displays purchase history data 27 of an individual customer ID which is assigned by inputting with keyboard 70c or by reading from a card. In addition, keyboard 70c is used for various other operations. Alternatively, a customer may input the customer ID (identification information) from keyboard 70c in order to assign the ID.

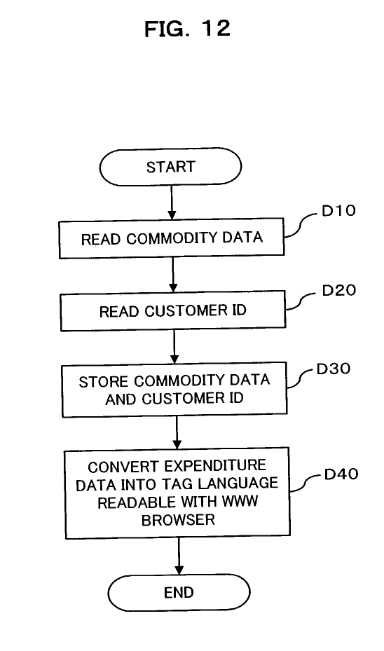

A succession of procedural steps (steps D10 to D40) for creating tag-language-converted customer household expenditure data for individual customers in POS system 100e using the above configuration will now be described with reference to flow chart FIG. 12.

First of all, a customer takes one or more commodities that the customer wishes to purchase to a cash register in the store. Barcode reader 22 installed disposed at POS terminal 20 is operated by a cashier to read barcodes attached to the commodities, so that POS terminal 20 obtains sales information including commodity name, quantity, price and the like (step D10) and sends the sales information to commodity sales managing unit 10. At that time, card reader 21 installed at POS terminal 20 reads the customer ID from a card presented by the customer (step D20).

Commodity sales managing unit 10 accumulates purchase history data 27 associated with the individual customer IDs and received from POS terminal 20, and stores the accumulated data as customer household expenditure data 61 for individual customers in storage 12 (step D30).

Commodity sales managing unit 10 converts the stored customer household expenditure data 61 into a tag language document (a tag-language format) to create tag-language-converted customer household expenditure data 62 for individual customers, which data can be read on a browser (step D40). After the conversion, commodity sales managing unit 10 stores created tag-language-converted customer household expenditure data 62 for individual customers ready to be browsed in response to a browsing request from outside commodity sales managing unit 10.

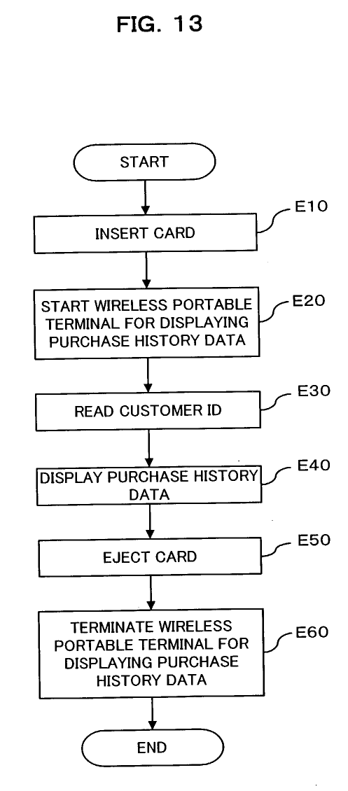

Next, a succession of procedural steps (steps E10 to E60) of browsing purchase history data 27 with the browsing terminal in POS terminal 100e of the fourth embodiment will now be described with reference to flow diagram FIG. 13.

A customer visits the store, and inserts a card in which a customer ID is previously registered into card slot 70b of browsing terminal 70 lent by the store (step E10). The insertion starts the browsing terminal 70 (step E20) and browsing terminal 70 reads the customer ID from the inserted card (step E30).

After that, browsing terminal 70 sends the read customer ID to commodity sales managing unit 10, obtains tag-language-converted customer household expenditure data 62 associated with the customer ID and displays the obtained data on display 70a (step E40).

After browsing desired purchase history data 27 (such as information on a commodity that the customer has purchased), the customer removes the card from card slot 70b (step E50) whereby the browsing terminal 70 is powered off (step E60).

As mentioned above, since POS system 100e of the fourth embodiment allows a customer to browse purchase history data 27 on browsing terminal 70, a customer can easily grasp the last time the customer purchased a particular commodity (such as food or a consumer goods) and judges the time of the next purchase.

Further, a customer can easily grasp information (such as manufacturer, commodity name, commodity type number) with ease so that the customer purchases the right consumption supplies for business machines or home appliances, without making a wrong choice. The service to customers is thereby improved.

In the store, customers communicate with commodity sales managing unit 10 using browsing terminals 70 provided by the store so that the customers are not asked for a charge for communication with commodity sales managing unit 10 whereupon the customer is satisfied with the service received from the store.

Since a customer ID is read simply by inserting a card in which the customer ID is previously registered into card slot 70b included in browsing terminal 70, customers do not have to input customer IDs by hand and customer service can be improved.

Browsing terminal 70 is a portable wireless-communication terminal wirelessly and communicably connected to commodity sales managing apparatus 10 so that customers can carry browsing terminal 70 in the store during shopping. Service to the customer is thereby improved.

Meanwhile, providing purchase history data 27 on browsing terminal 70 offers customers better service more efficiently by reducing inquires from customers and also reduces returns and complaints caused by purchase of wrong commodities whereupon the store can advantageously enclose customers and expect repeat customers.

In the illustrated example, browsing terminal 70 takes the form of a portable wireless-communication terminal wirelessly and communicably connected to commodity sales managing unit 10, but should by no means be limited to the portable terminal. Alternatively, browsing terminal 70 may be installed at a fixed place in the store.

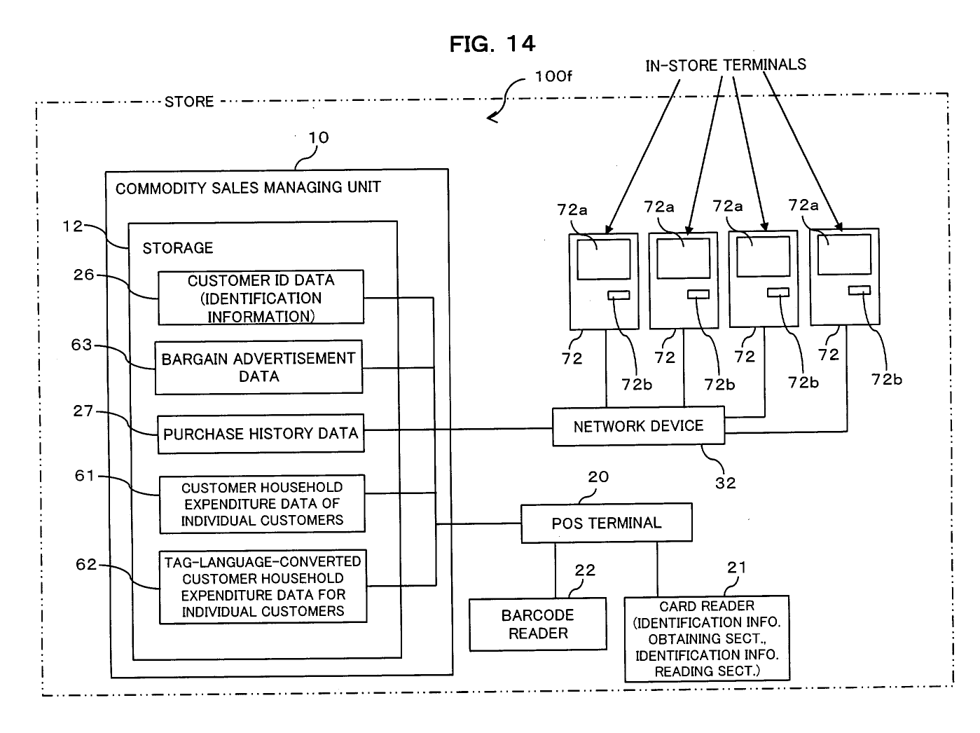

FIG. 14 is a block diagram schematically showing POS system 100f according to a modification of the fourth embodiment. As shown in FIG. 14, POS system 100f of the modification includes network device 32 and in-store terminal 72, as substitutes for wireless communication device 31 and browsing terminal 70 in POS system 100e, respectively. Additionally, storage 12 in commodity sales managing unit 10 includes bargain advertisement data 63.

Like reference numbers designate similar or substantially similar parts or elements throughout the above description, so any repetitious description is omitted here.

Bargain advertisement data (value-added information) 63 is picture data or the like used for advertising bargains and is stored in storage 12. Commodity sales managing unit 10 sends bargain advertisement data 63 to in-store terminal 72 together with tag-language-converted customer household expenditure data 62 for individual customers. Bargain advertisement data 63 may be still or motion picture data.

Network device 32 is exemplified by a LAN board, a LAN cable and/or a HUB, and communicably connects commodity sales managing unit 10 and in-store terminal 72.

Each in-store terminal 72 is a fixed-type terminal installed in the store. Customers browse tag-language-converted customer household expenditure data 62 associated with individual customers on in-store terminal(s) 72.

As shown in FIG. 14, each in-store terminal 72 includes a keyboard (an assigning section, not-shown), display 72a and card slot (an assigning section) 72b.

Each in-store terminal 72 is communicably connected to commodity sales managing unit 10 via network device 32, and displays tag-language-converted customer household expenditure data for individual customers, which data is managed by commodity sales managing unit 10, on display 72a thereof.

Specifically, browsing software is installed in in-store terminal 72 so that in-store terminal 72 displays tag-language documents on display 72a. Further, in-store terminal 72 displays bargain advertisement data 63 sent from commodity sales managing unit 10 together with a tag-language document. Card slot 72b functions in the same way as card slot 70b of browsing terminal 70 in POS system 100e.

Also in POS system 100f having the foregoing configuration, customers can browse, on display 72a of browsing terminal 72, tag-language-converted customer household expenditure data for individual customers, which data is stored in storage 12 of commodity sales managing unit 10. Thereby, this modification can ensure the same advantages as those of the fourth embodiment. Further, it is possible for this modification to reduce facility costs by using fixed-type in-store terminal(s) 72 which is/are cheaper than portable wireless-communication terminal(s) able to wirelessly communicate with commodity sales managing unit 10.

In the store also utilizing the POS system 100f, customers communicate with commodity sales managing unit 10 using browsing in-store terminals 72 installed in the store so that the customers are not charged for communicating with commodity sales managing unit 10 whereupon the customer is satisfied with the service received from the store.

Since communication between commodity sales managing unit 10 and each in-store terminal 72 is executed through the in-house network of the store, the store manages to ensure security of the network with ease.

(E) Fifth Embodiment:

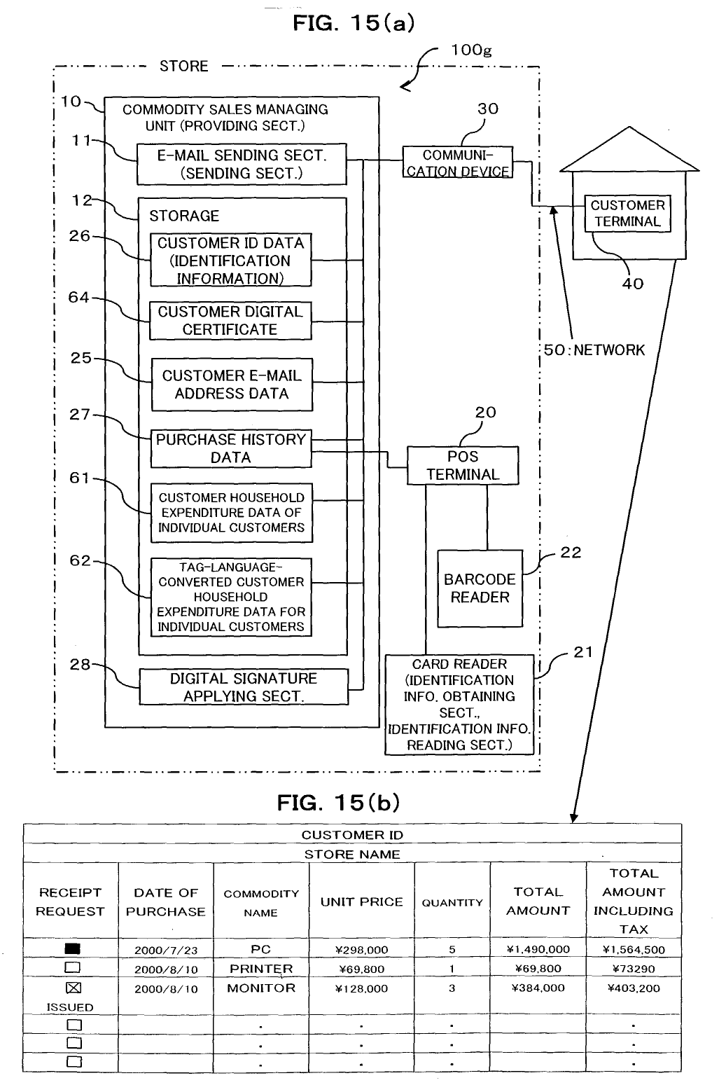

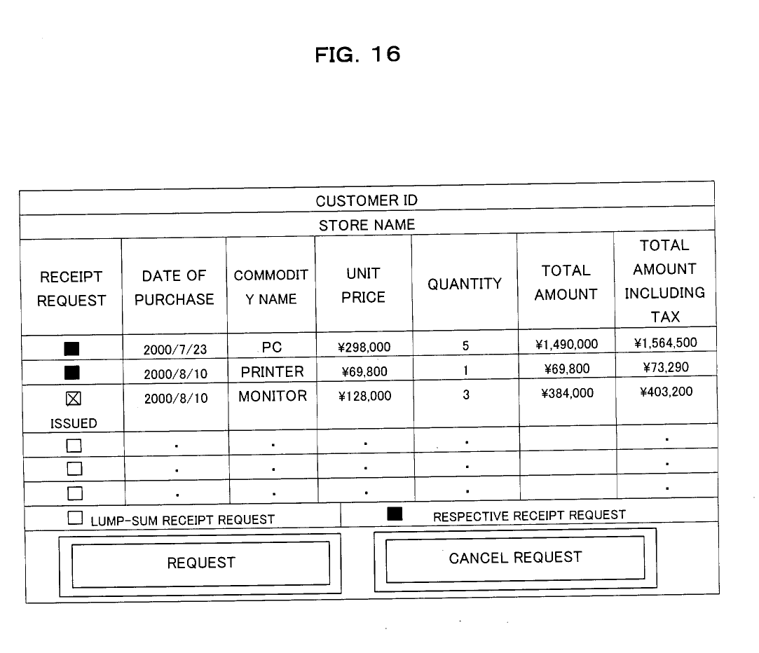

FIG. 15(a) is a block diagram schematically showing POS system 100g according to the fifth embodiment of the present invention; FIG. 15(b) is a diagram illustrating an example of tag-language-converted customer household expenditure data for an individual customer displayed on the display of customer terminal 40 (not illustrated) in POS system 100g; and FIG. 16 is a diagram illustrating a screen to be displayed on the display of customer terminal 40 in order to request issuing of a receipt.

As shown in FIG. 15(a), POS system 100g of the fifth embodiment is similar to POS system 100a of the first embodiment and includes, in storage 12 of commodity sales managing unit 10, customer digital certificate 64, customer household expenditure data 61, and tag-language-converted customer household expenditure data 62, as substitutes for appointed day data 23 and to-be-sent purchase history/accumulation period data 24 of the first embodiment. In addition, POS system 100g includes digital signature applying section 28 identical to that of the second embodiment.

Like reference numbers designate similar or substantially similar parts or elements throughout the above description, so any repetitious description is omitted here.

Commodity sales managing unit 10 of POS system 100g of the fifth embodiment serves as a commodity sales managing server (a www server) to disclose tag-language-converted customer household expenditure data 62 on a web page (a browse page). When a customer assigns his/her customer ID with customer terminal 40 in which browsing software is installed, the customer browses purchase history data 27 (i.e., tag-language-converted customer household expenditure data 62) associated with the assigned customer ID, as shown in FIG. 15(b).

In other words, commodity sales managing unit 10 serves as a www server so as to function as a providing section to provide, responsive to a browsing request assigning a customer ID (identification information), purchase history data 27 (i.e., tag-language-converted customer household expenditure data 62) associated with the assigned customer ID, which data is stored in storage 12, so that the customer can browse the purchase history data 27 associated with the assigned customer ID.

Further, commodity sales managing unit 10 may require a customer to input a password along with the customer ID when the customer attempts to access commodity sales managing unit 10 through network 50, thereby protecting the privacy of each customer and improving the authenticity of the POS system.

A customer can request commodity sales managing unit 10 to issue a receipt in relation to purchase history data 27 displayed on the display of customer terminal 40. Specifically, as shown in FIG. 15(b), the customer requests a receipt to be issued for one or more particular purchased commodities in the displayed purchase history data 27, which commodities are selected by marking the check box representing a receipt request for the corresponding purchase using a mouse (not shown) of customer terminal 40 with a check mark.

Further, the check box of a receipt request for a purchased commodity for which a receipt has already been issued is indicated by a mark (an “X” and “done”) which states that the receipt has already been issued, as shown in FIG. 15(b). Such indication eliminates the possibility of redundant issuing of receipts for an individual purchase.

After the customer has marked a check box of a receipt request for a purchased commodity, a click on the “REQUEST” button shown in FIG. 16 sends a request for issuing of a receipt to commodity sales managing unit 10. Conversely, a click on the “CANCEL REQUEST” button cancels sending of the receipt issuing request to commodity sales managing unit 10.

If a customer wishes to obtain receipts, one for each of a number of purchased commodities, a check mark applied to the “RESPECTIVE RECEIPT REQUEST” region issues respective receipts one for each purchased commodity. On the other hand, if the “LUMP-SUM RECEIPT REQUEST” region is selected by applying a check mark to the region, a receipt is issued for a number of purchased commodities in a lump. Each customer can arbitrarily select a method of receipt isse.

Meanwhile, upon receipt of a receipt issuing request from customer terminal 40, commodity sales managing unit 10 sends the e-mail address of the customer one or more receipts for the one or more designated commodities by e-mail.

Namely, commodity sales managing unit 10 serves as a receipt issuing section to issue, based on the purchase history data 27, a receipt for one or more purchased commodities designated by customer terminal 40, which receipt is in the form of electronic data.

More specifically, commodity sales managing unit 10 obtains, from customer e-mail address data 25, the e-mail address corresponding to the customer ID and then, on the basis of purchase history data 27, causes e-mail sending section 11 to send one or more receipts for the one or more designated purchased commodities by e-mail.

Accordingly, e-mail sending section 11 also serves as a sending section to send an issued receipt to a customer identified by a customer ID.

Customer digital certificate 64 is certificate data with which an individual customer is identified, and stores, for example, the public key of each customer. Digital signature applying section 28 uses the public key of a customer, which key is registered in customer digital certificate 64, to apply a digital signature to purchase history data 27 that is to be sent to the customer.

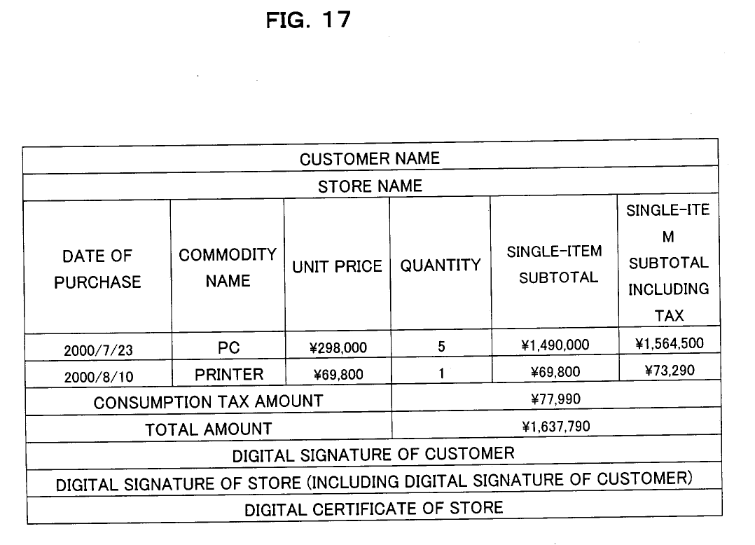

FIG. 17 illustrates an example of purchase history data 27 to be sent to a customer from commodity sales managing unit 10 in POS system 100g of the fifth embodiment. As shown in FIG. 17, to-be-sent purchase-history data includes a digital signature (a customer digital signature) applied using a customer public key in addition to the store digital signature and the store digital certificate.

A customer public key is previously stored in a customer digital certificate of commodity sales managing unit 10 in correlation with an individual customer ID. Alternatively, a customer public key may be previously registered in the card that is to be read by card reader 21. Digital signature applying section 28 obtains a customer public key and applies the obtained customer public key when a digital signature is applied.

Applying a digital signature to a receipt using a customer public key can prove that the receipt has definitely been issued to the customer.

Similar to digital signature applying section 28 in POS system 100b of the second embodiment, digital signature applying section 28 of the fifth embodiment may apply a digital signature, using the store digital signature and the store digital certificate, to a receipt that is to be issued to a customer who does not have a customer public key.

In POS system 100g having the above configuration, when a customer pays for a purchase at a cash register, card reader 21 installed at POS terminal 20 reads the customer ID, and then information of the read customer ID and information on one or more commodities read by barcode reader 22 are sent to commodity sales managing unit 10.

Upon receipt of the information, commodity sales managing unit 10 stores information (e.g., commodity name, unit price, quantity, bill amount (total amount), date and time, seller information used to identify the store that sold the commodities) on the purchase of the commodities as purchase history data 27, accumulates the purchase history data 27 in association with the customer ID and rearranges the purchase history data 27 in a predetermined order whereupon the purchase history data 27 is stored as customer household expenditure data 61 for individual customers.

Further, commodity sales managing unit 10 converts customer household expenditure data 61 for individual customers into tag-language documents and thereby creates tag-language-converted customer household expenditure data 62 for individual customers, which data is to be stored in storage 12.

A customer accesses commodity sales managing unit 10 via network 50 by using browsing software installed in customer terminal 40 and assigns his/her customer ID to browse purchase history data 27 (tag-language-converted customer household expenditure data 62) corresponding to the customer ID.

After that, with reference to the purchase history data 27 displayed on the display of customer terminal 40, the customer marks a check on a commodity for which the customer wants a receipt and clicks the “RECEIPT REQUEST” button so that the customer requests commodity sales managing unit 10 to issue the receipt.

In response to the request from the customer, commodity sales managing unit 10 creates the receipt and causes digital signature applying section 28 to apply a digital signature to the created receipt. Then commodity sales managing unit 10 refers to customer e-mail address data 25 and sends the receipt to an e-mail address of the customer by e-mail. The customer uses the receipt for filing a final tax return or a blue-form tax return, or other purposes.

As mentioned above, POS system 100g of the fifth embodiment receives a request for a receipt that a customer makes using customer terminal 40 whereby the customer does not have to wait for issuing of the receipt at the store and can be further satisfied with service from the store. Additionally, even if a customer forgot to request a receipt at a cash register when purchasing a commodity, the customer can receive the receipt from the store with ease.

Also, the store can advantageously reduce cashier labor used in issuing receipts, thereby becoming more efficient.

In POS system 100g of the fifth embodiment, a customer uses customer terminal 40 to access commodity sales managing unit 10 for a receipt issuing request, but the receipt issuing request manner should by no means be limited to from customer terminal 40. Alternatively, a customer may make a request for receipt issuing from a terminal disposed in the store.

In this case, if POS system 100g is configured such that a customer inserts a card, in which the corresponding customer ID is previously registered, into the terminal and the terminal reads the customer ID, which is to be used for an access to commodity sales managing unit 10, it is possible to greatly reduce the customer's task of inputting the customer ID, thereby improving reliability of the POS system.

Further, since digital signature applying section 28 applies a digital signature using a public key of a customer to a receipt destined for the customer, it is possible to prove that the receipt has definitely been issued to the customer. That eliminates the possibility of a third party unscrupulously using the receipt.

(F) Others:

The present invention should by no means be limited to the foregoing embodiments and various changes and modifications can be suggested without departing from the concept of the present invention.

In the first to fifth embodiments, identification information used for identification of individual customers is customer IDs, but should by no means be limited to the customer IDs. As an alternative, customer e-mail addresses may be used as identification information used for identification of individual customers.

In this case, commodity sales managing unit 10 can manage without a table having the correlation between a customer ID and an associated e-mail address by treating customer e-mail addresses as customer IDs.

However, if customer e-mail addresses are used as identification information, the basis for identification changes each time an e-mail address of the customer changes, and management of identification information becomes complicated making use of customer IDs preferable.

In POS systems 100e and 100f of the fourth embodiment and a modification thereof, commodity sales managing unit 10 converts customer household expenditure data 61 for individual customers into tag-language-converted customer household expenditure data 62 for individual customers, which is stored in commodity sales managing unit 10, and browsing terminal 70 and in-store terminal 72 installs software able to display tag-language documents therein. But, commodity sales managing unit 10 and browsing terminal 70 and in-store terminal 72 should by no means be limited to these.

For the present invention, it is sufficient that a customer can confirm the contents of customer household expenditure data 61 for individual customer displays with reference information displayed on displays 70a and 72a of browsing terminal 70 and in-store terminal 72. Alternatively, displays 70a and 72a of browsing terminal 70 and 72 may display customer household expenditure data 61 in the form of another data format, such as text data, image data, or spreadsheet data. Information displayed on displays 70a and 72a may be modified without departing from the gist of the present invention.

Further, commodity sales managing unit 10 of POS system 100f of the described modification of the fourth embodiment includes bargain advertisement data 63 in storage 12 and displays bargain advertisement data 63 on in-store terminal 72. POS systems 100a, 100b, 100c, 100d, 100e and 100g of the other embodiments and modification may display bargain advertisement data 63 on customer terminal 40 and/or browsing terminal 70.

Still further, in the fourth embodiment, when a card is inserted into card slot 70b of browsing terminal 70, browsing terminal 70 starts and reads the customer ID registered in the inserted card. But, the manner for obtaining a customer ID should by no means be limited to this example. Alternatively, browsing terminal 70 may have a power-supply switch, which is operated by a customer to apply power to browsing terminal 70, and then the customer may input the corresponding customer ID with keyboard 70c. A customer ID obtaining manner can be altered or modified without departing from the concept of the present invention.

In the foregoing embodiments, card reader 21 serves as an identification information reading section to read a customer ID from a card, but the present invention should by no means be limited to this. Alternatively, a customer ID may be previously registered on a token possessed by a customer so that a customer ID may be obtained from such a token; or a customer ID (identification information) may be extracted and obtained from customer biometric information (e.g., fingerprint, voice print, iris, retina, palm shape, ear shape, dynamic signature, keystroke, blood vessel pattern, face image).

Still further, two or more of the foregoing POS systems 100a, 100b, 100c, 100d, 100e, 100f and 100g may be combined to embody the present invention.

### Industrial Applicability

As described above, the POS system of the present invention advantageously manages purchase history of individual customers, and is particularly suitable for sending purchase history data and receipts to individual customers.

What is claimed is:

1. A POS (point-of-sale) system comprising:
a POS terminal (20) to obtain sales information about one or more commodities, which are sold to a customer, at a point of sale; and
a commodity sales managing apparatus (10), communicably connected to said POS terminal (20), to manage the sales information received from said POS terminal (20); wherein
said POS terminal (20) has an identification information obtaining section (21) to obtain identification information, which is used for identification of the customer, at the point of sale so that the identification information is sent to said commodity sales managing apparatus (10) along with the sales information, and
said commodity sales managing apparatus (10) has
a purchase history data creating section (13) to create purchase history data by converting the sales information, received from said POS terminal (20), into predetermined format data,
a storage (12) to store the purchase history data associated with the identification information, and
a sending section (11) to send, on an appointed day, the purchase history data concerning a predetermined time period to the customer identified by the identification information.

2. A POS system according to claim 1, wherein said commodity sales managing apparatus (10) further comprises a digital signature applying section (28) to apply a digital signature to the purchase history data that is to be sent to the customer by said sending section (11).

3. A POS (point-of-sale) system comprising:
a POS terminal (20) to obtain sales information about one or more commodities, which are sold to a customer, at a point of sale; and
a commodity sales managing apparatus (10), communicably connected to said POS terminal (20), to manage the sales information received from said POS terminal (20); wherein
said POS terminal (20) has an identification information obtaining section (21) to obtain identification information, which is used for identification of the customer, at the point of sale so that the identification information is sent to said commodity sales managing apparatus (10) along with the sales information, and
said commodity sales managing apparatus (10) has
a purchase history data creating section (13) to create purchase history data by converting the sales information, received from said POS terminal (20), into predetermined format data,
a storage (12) to store the purchase history data associated with the identification information,
a sending section (11) to send the purchase history data stored in said storage (12) to the customer identified by the identification information, and
a digital signature applying section (28) to apply a digital signature to the purchase history data that is to be sent to the customer by said sending section (11).

4. A POS system according to one of claims 1-3, wherein said sending section (11) sends the purchase history data to the customer through the Internet.

5. A POS system according to claim 4, wherein said sending section (11) sends the purchase history data to the customer by e-mail (electronic mail).

6. A POS (point-of-sale) system comprising:
a POS terminal (20) to obtain sales information about one or more commodities, which are sold to a customer, at a point of sale; and
a commodity sales managing apparatus (10), communicably connected to said POS terminal (20), to manage the sales information received from said POS terminal (20); wherein
said POS terminal (20) has an identification information obtaining section (21) to obtain identification information, which is used for identification of the customer, at the point of sale so that the identification information is sent to said commodity sales managing apparatus (10) along with the sales information,
said commodity sales managing apparatus (10) has
a purchase history data creating section (13) to create purchase history data by converting the sales information, received from said POS terminal (20), into predetermined format data, and
a storage (12) to store the purchase history data associated with the identification information, and
said POS system further comprises a browsing terminal (70, 72) including
an assigning section (70b, 70c, 72b) to assign the identification information, and
a display (70a, 72a) to display the purchase history data associated with the identification information assigned by said assigning section (70b, 70c, 72b), which data is stored in said storage (12).

7. A POS system according to one of claims 1-5, further comprising a browsing terminal (70, 72) including
an assigning section (70b, 70c, 72b) to assign the identification information, and
a display (70a, 72a) to display the purchase history data associated with the identification information assigned by said assigning section (70b, 70c, 72b), which data is stored in said storage (12).

8. A POS system according to claim 6 or 7, wherein
said browsing terminal (70, 72) further includes an identification information reading section (70b, 72b) to read the identification information from a medium (71) in which the identification information is recorded, and
said assigning section (70b, 70c, 72b) assigns the identification information read by said identification information reading section (70b, 72b).

9. A POS system according to one of claims 6-8, wherein said browsing terminal (70, 72) is a portable wireless-communication terminal wirelessly and communicably connected to said commodity sales managing apparatus (10).

10. A POS (point-of-sale) system comprising:
a POS terminal (20) to obtain sales information about one or more commodities, which are sold to a customer, at a point of sale; and
a commodity sales managing apparatus (10), communicably connected to said POS terminal (20), to manage the sales information received from said POS terminal (20); wherein
said POS terminal (20) has an identification information obtaining section (21) to obtain identification information, which is used for identification of the customer, at the point of sale so that the identification information is sent to said commodity sales managing apparatus (10) along with the sales information, and
said commodity sales managing apparatus (10) has
a purchase history data creating section (13) to create purchase history data by converting the sales information, received from said POS terminal (20), into predetermined format data,
a storage (12) to store the purchase history data associated with the identification information,
a providing section (10) to provide the purchase history data stored in said storage (12) responsive to a browse request that assigns the identification information so that the purchase history data associated with the identification information is browsed, and
a receipt issuing section (10) to issue, based on the purchase history data, a receipt for one or more purchased commodities designated with reference to the purchase history data provided by said providing section (10), which receipt is in the form of electronic data.

11. A POS system according to claim 10, wherein said commodity sales managing apparatus (10) further has a sending section (11) to send the receipt, issued by said issuing section (10), to the customer identified by the identification information.

12. A POS system according to claim 11, wherein said sending section (11) sends the receipt to the customer by e-mail (electronic mail).

13. A POS system according to claim 10 or 11, wherein said commodity sales managing apparatus (10) further has a digital signature applying section (28) to apply a digital signature to the receipt that is to be sent to the customer by said sending section (11).

14. A POS system according to claim 13, wherein said digital signature applying section (28) applies the digital signature to the receipt using a secret key of the customer.

15. A POS terminal according to one of claims 10-14, wherein said receipt issuing section (10) issues the receipt for each of the purchased commodities designated with reference to the purchase history data provided by said providing section (10).

16. A POS terminal according to one of claims 10-14, wherein said receipt issuing section (10) issues the receipt for the purchased commodities, designated with reference to the purchase history data provided by said providing section (10), in a lump.

17. A POS system according to one of claims 10-16, wherein said providing section (10) displays the purchase history data on a browse page and displays value-added information on the browse page.

18. A POS system according to one of claims 1-17, wherein said identification information obtaining section (21) serves to function as an identification information reading section (21) to read the identification information from a medium (71) in which the identification information is recorded.

19. A POS system according to one of claims 1-18, the purchase history data includes date and time of purchase, information about each purchased commodity, and information of prices of each purchased commodity.

20. A POS system according to one of claims 10-19, the receipt issuing section (10) issues the receipt in the form of electronic data including date and time of purchase, information about each purchased commodity, information of prices of each purchased commodity and information of a seller of the purchased commodities.

21. A commodity sales managing apparatus, communicably connected to a POS terminal (20) to obtain sales information about one or more commodities which are sold to a customer at a point of sale, for managing the sales information received from the POS terminal (20), said apparatus comprising:
a purchase history data creating section (13) to create purchase history data by converting the sales information, received from the POS terminal (20), into predetermined format data;
a storage (12) to store the purchase history data associated with identification information, which is received from the POS terminal (20) and which is used for identification of the customer; and
a sending section (11) to send, on an appointed day, the purchase history data concerning a predetermined time period to the customer identified by the identification information, which data is stored in said storage (12).

22. A commodity sales managing apparatus, communicably connected to a POS terminal (20) to obtain sales information about one or more commodities which are sold to a customer at a point of sale, to manage the sales information received from the POS terminal (20), said apparatus comprising:
a purchase history data creating section (13) to create purchase history data by converting the sales information, received from the POS terminal (20), into predetermined format data;
a storage (12) to store the purchase history data associated with identification information, which is received from the POS terminal (20) and which is used for identification of the customer;
a sending section (11) to send the purchase history data stored in said storage (12) to the customer identified by the identification information; and
a digital signature applying section (28) to apply a digital signature to the purchase history data that is to be sent to the customer by said sending section (11).

23. A commodity sales managing apparatus, communicably connected to a POS terminal (20) to obtain sales information about one or more commodities which are sold to a customer at a point of sale, to manage the sales information received from the POS terminal (20), said apparatus comprising:
a purchase history data creating section (13) to create purchase history data by converting the sales information, received from the POS terminal (20), into predetermined format data;
a storage (12) to store the purchase history data associated with identification information, which is received from the POS terminal (20) and which is used for identification of the customer;
a providing section (10) to provide the purchase history data stored in said storage (12) responsive to a browse request that assigns the identification information so that the purchase history data associated with the identification information is browsed; and
a receipt issuing section (10) to issue, based on the purchase history data, a receipt for one or more purchased commodities designated with reference to the purchase history data provided by said providing section (10), which receipt is in the form of electronic data.

24. A purchase history data browsing terminal provided in a POS (point-of-sale) system comprising a POS terminal (20) to obtain sales information about one or more commodities, which are sold to a customer, at a point of sale; and a commodity sales managing apparatus (10), communicably connected to said POS terminal (20), to manage the sales information received from said POS terminal (20), wherein said POS terminal (20) has an identification information obtaining section (21) to obtain identification information, which is used for identification of the customer, at the point of sale so that the identification information is sent to said commodity sales managing apparatus (10) along with the sales information, and said commodity sales managing apparatus (10) has a purchase history data creating section (13) to create purchase history data by converting the sales information, received from said POS terminal (20), into predetermined format data, and a storage (12) to store the purchase history data associated with the identification information, said purchase history data browsing terminal comprising:
an assigning section (70b, 70c, 72b) to assign the identification information; and
a display (70a, 72a) to display the purchase history data associated with the identification information assigned by said assigning section (70b, 70c, 72b), which data is stored in said storage (12).

25. A purchase history data browsing terminal according to claim 24, wherein
said browsing terminal further comprises an identification information reading section (70b, 72b) to read the identification information from a medium (71) in which the identification information is recorded, and
said assigning section (70b, 70c, 72b) assigns the identification information read by said identification information reading section (70b, 72b).

26. A purchase history data browsing terminal according to claims 24 or 25, wherein said purchase history data browsing terminal is a portable wireless-communication terminal wirelessly and communicably connected to said commodity sales managing apparatus (10).
